(19) United States
(12) Patent Application Publication
(10) Pub. No.: US 2011/0104488 A1
(43) Pub. Date: May 5, 2011

(54) PRESSURE-SENSITIVE ADHESIVE COMPRISING A CROSSLINKABLE POLYOLEFIN AND A TACKIFIER RESIN

(75) Inventors: Bernhard Müssig, Seevetal (DE); Kerstin Metzler, Hamburg (DE)

(73) Assignee: tesa SE, Hamburg (DE)

(21) Appl. No.: 12/913,927

(22) Filed: Oct. 28, 2010

(30) Foreign Application Priority Data
Nov. 3, 2009 (DE) 10 2009 046 362.3

(51) Int. Cl. B32B 7/12; C08L 51/08; B05D 5/10

(52) U.S. Cl. 428/355 EN; 525/55; 525/63; 428/355 BL; 428/355 AC; 428/317.3; 427/208.4

(57) ABSTRACT

Pressure-sensitive adhesive comprising a crosslinkable polyolefin and at least one tackifier resin, wherein the polyolefin is composed of at least two monomers A and B and of at least one comonomer C amenable to crosslinking, the monomers A and B being selected from the group consisting of α-olefins, vinyl acetate, n-butyl acrylate and methyl methacrylate or, in the case of EPDM, a diene such as 5-ethylidene-2-norbornene, dicyclopentadiene or 5-vinyl-2-norbornene.

The invention relates to a pressure-sensitive adhesive (PSA) comprising a crosslinkable polyolefin and at least one tackifier resin, to methods for applying the PSA as a solvent composition or hotmelt adhesive, and to use in an adhesive tape.

Random copolymers with a high comonomer fraction (also called plastomers) have a low crystallinity and low melting point of approximately 40° C. to 60° C. or are amorphous. They are used as flexibilizers or impact toughener additives for hard polyolefins. They are used only to a limited extent for hotmelt adhesives, since the low melting point means that they are not heat-resistant.

Such plastomers are proposed as a coextrusion layer for slightly tacky and readily redetachable surface protection films. These films at room temperature have no significant bond strength (in other words, below 0.1 N/cm), but above the melting point can be sealed to panels of polycarbonate, acrylic glass or ABS as protection from scratching, and later removed again at room temperature. Surface protection films made from random copolymers with a high comonomer fraction do not have good storage qualities, since in the event of a lightly elevated storage temperature, the rolls suffer blocking, which means that they cannot be unrolled again, and they also have no heat resistance for the user.

It is therefore usual to use random copolymers having a low comonomer fraction and therefore having a higher melting point of above 60° C., despite the fact that a higher sealing temperature is then necessary. These films are not tacky at room temperature. Alternatively, films with a PSA coating of polyacrylate or synthetic rubber are also used.

Plastomers are also proposed for surface protection films which are tacky at room temperature (23° C.). Through the addition of a small amount of plasticizer or tackifier (tackifying resin), the crystallinity is reduced to an extent such that good tack is achieved even at room temperature, at least on smooth plastic panels or polished steel panels. Such adhesives, however, have an even lower heat resistance than coextrusion layers with a soft random copolymer, and therefore are not used as PSAs for industrial adhesive tapes. Moreover, following removal from such panels, they leave behind a thin and yet visible covering, which the skilled person refers to as ghosting. For these reasons they have not become established for the stated applications.

For tacky surface protection films, therefore, it is usual to use films having a coating of polyacrylate adhesive or synthetic rubber adhesive.

Where adhesives comprising a tackifier resin and a polyolefin homopolymer such as LDPE (PE-LD) or polypropylene homopolymer, or a copolymer with a low comonomer fraction, such as random polypropylene, are prepared for sealing layers or LLDPE (PE-LLD), they prove not to be tacky.

Adhesive tapes comprise or consist of at least one layer of (pressure-sensitive) adhesives, which are typically based on natural rubber, synthetic rubber (for example polyisobutylene, styrene block copolymer, EVA, SBR), in combination with a tackifier resin or polyacrylate, and, very rarely, of very expensive silicone. The typical PSAs have the properties of high bond strength, shear strength, capacity for solventless processing from the melt, high water resistance (in contrast to dispersion-based coatings), favourable costs, or high heat-ageing stability and UV stability.

Adhesive tapes ought to contain PSAs (adhesives) which have high bonding strengths (bond strengths) and shear strength (resistance to cold flow) at room temperature and usually at elevated temperatures as well. For this reason, adhesive tapes are typically manufactured with adhesives based on natural rubber, styrene block copolymer and acrylate. The natural rubber adhesives contain solvent and have low ageing stability and UV stability. Styrene block copolymer adhesives, generally based on styrene-isoprene-styrene block copolymers, can be processed solventlessly, but likewise have low ageing stability and UV stability. Adhesives based on hydrogenated styrene block copolymers are very expensive, have low tack (stickiness) and bond strength, and therefore adhere poorly to many substrates. They likewise soften at well below 100° C. Acrylate adhesives have good ageing stability and UV stability, but adhere poorly to low-energy, apolar polymers such as polyethylene, for example, in spite of all of the efforts to date. Silicone PSAs have good ageing stability and UV stability and good adhesion, especially to low-energy surfaces, but are extremely expensive and cannot be lined with the standard siliconized liners (or cannot be removed from them again).

There has long been a desire for an adhesive which combines the positive properties of the various adhesives with one another: high bond strength, not least on low-energy surfaces, and ageing stability and UV stability like those of acrylate adhesives, and also favourable costs and a sufficient shear strength.

It is an object of the invention to provide a PSA for, for example, an adhesive tape, which has the outlined advantages and at the same time does not have the disadvantages of the prior art.

This object is achieved by means of a pressure-sensitive adhesive as recorded in the main claim. Advantageous developments of the subject matter of the invention and also uses of the adhesive are given in the dependent claims.

The core point of the invention is a crosslinkable polyolefin in a pressure-sensitive adhesive comprising at least three different monomers, as an alternative to natural rubber or to styrene block copolymers such as SIS, which allows the production of inexpensive, ageing-stable adhesive tapes which through crosslinking possess shear strength.

In the text below, the term pressure-sensitive adhesive is often abbreviated to PSA. PSAs in the sense of the invention are those capable of giving an adhesive tape a bond strength to steel of at least 0.5 N/cm, preferably at least 1 N/cm.

The invention accordingly provides a pressure-sensitive adhesive comprising a crosslinkable polyolefin and at least one tackifier resin, wherein the polyolefin is composed of at least two monomers A and B and of at least one comonomer C amenable to crosslinking, the monomers A and B being selected from the group consisting of α-olefins, vinyl acetate, n-butyl acrylate and methyl methacrylate or, in the case of EPDM, a diene such as 5-ethylidene-2-norbornene, dicyclopentadiene or 5-vinyl-2-norbornene. The monomers A and B of the crosslinkable polyolefin are preferably selected from the group of the α-olefins, more preferably from the group of ethylene, propylene, butene, hexene and octene.

The term “polyolefin” in this invention encompasses not only polyolefins in the strictly scientific sense, composed exclusively of α-olefin monomers, but also the designation, customary among plastics technicians, for polyolefins which are composed primarily of α-olefin monomers, but may comprise, in copolymerized form, monomers such as, for example, vinyl acetate, n-butyl acrylate, methyl methacrylate, acrylic acid, glycidyl methacrylate or vinylsilane (for example vinyltriacetoxysilane, vinyltriethoxysilane), or may be grafted with comonomers such as silanes, glycidyl methacrylate or maleic anhydride.

Crosslinkable comonomers for the purposes of this invention are those which following incorporation (by copolymerization or grafting) into a polymer, allow chemical crosslinking of the polymer. These comonomers do include dienes, which, however, are crosslinkable only under drastic conditions (time, temperature) with peroxides or sulphur-based vulcanization. Preference is therefore given to other crosslinkable comonomers which allow chemical crosslinking under customary production conditions in the PSA industry. These comonomers are more preferably those known from the prior art in acrylate PSAs, and comprise especially glycidyl methacrylate, maleic anhydride, and fumaric, itaconic, acrylic and methacrylic acid.

Preferred crosslinkable polyolefins are, first, terpolymers of ethylene, vinyl acetate, esters of acrylic acid or methacrylic acid and of a comonomer which is amenable to crosslinking, such as vinylsilane, glycidyl methacrylate, maleic anhydride, acrylic or methacrylic acid, and, secondly, copolymers or terpolymers grafted with the comonomer and selected from the group of copolymers of ethylene and propylene, of copolymers of propylene and butene, of copolymers of ethylene and octene, and of terpolymers of ethylene, propylene and of diene preferably from the group of 5-ethylidene-2-norbornene, dicyclopentadiene and 5-vinyl-2-norbornene.

Polyolefins of this kind have to date been used not for PSAs, but instead in coextruded films as an adhesion promoter layer between a polyolefin layer and a polyamide layer, as impact modifiers in polyamide, for improving the strength of glass fibre-reinforced polyolefin compounds, and as a sealing layer on polyolefin films for lamination to composite aluminium foils.

Commercial terpolymers of ethylene, acrylic acid or methacrylic acid and an ester of acrylic or methacrylic acid feature a high fraction of acids, which do exhibit high adhesion to polar substrates such as metal, PVC, polycarbonate, Plexiglas or paints, but are not removable again, and which theoretically permit a high degree of crosslinking. These properties result in preferred fields of application for PSAs.

Commercial copolymers of ethylene and/or propylene or EPDM rubber, grafted with maleic anhydride, have a low acid content and therefore potentially can also be removed again from polar substrates.

Polyolefins with incorporation of the comonomer by grafting by means of peroxides in a reaction extruder are used not so much for solvent compositions, owing to the risk of gel fractions, but instead are used more for hotmelt PSAs. One of the advantages is the unrestricted availability of such polyolefins on the market, and the ready availability in the case of in-house manufacture. Secondly, it is possible to avoid solvents. Polyolefins with incorporation of the comonomer by copolymerization are suitable for both kinds of adhesives; on account of the good solubility, applications from solution are preferred, which are difficult or impossible to realize with hotmelt PSAs, for example, at low coatweights.

In accordance with one advantageous embodiment of the invention, the amount of comonomer C in the polyolefin is in the range from 0.4% to 5% by weight.

On account of the shear strength, the polyolefin of the invention preferably has a melt index of less than 10, more preferably less than 1, more particularly less than 0.5, and especially less than 0.1 g/10 min. If the requirements imposed on the shear strength are not exacting, but good processing properties are important, the melt index ought to be greater than or equal to 0.5 g/10 min. The melt index is tested in accordance with ISO 1133 under 2.16 kg and is expressed in g/10 min. The values stated in this disclosure are determined—as is familiar to the skilled person—at different temperatures, as a function of the principal monomer of the polyolefin; in the case of predominantly ethylene- or butene-containing polymers the relevant temperature is 190° C., and in the case of predominantly propylene-containing polymers it is 230° C.

The Mooney viscosity of the polyolefin is preferably greater than 5, more preferably greater than 35, and more particularly greater than 60. It is determined in accordance with ASTM D 1646 under the conditions ML 1+4 at 125° C.

In the case of maleic anhydride-containing polymers, ingress of moisture may be accompanied by hydrolysis of the anhydride ring, and this may influence the melt index and the Mooney viscosity.

The flexural modulus of the polyolefin is preferably less than 50 MPa, more preferably less than 26 MPa; the polyolefin is preferably amorphous and/or has a crystallite melting point of below 105° C. The heat of fusion is preferably below 18 J/g, more preferably below 3 J/g.

Excessive deviation from these properties causes the crystallinity to become too high and hence results in a low tack.

The flexural modulus can be determined in accordance with ASTM D 790 (secant modulus at 2% strain).

The crystallite melting point and the heat of fusion of the polyolefin are determined by DSC (Mettler DSC 822) with a heating rate of 10° C./min in accordance with ISO 3146. Where two or more melt peaks occur, the crystallite melting point selected is that having the highest temperature, and the heat of fusion is determined from the sum of all the melt peaks. Where the polyolefin of the invention is prepared by grafting, by addition of a masterbatch of monomer or peroxide in another polyolefin, the crystallite melting point and the heat of fusion thereof are disregarded.

The amount of polyolefin of the invention in the pressure-sensitive adhesive is preferably between 15% and 60% by weight, more preferably between 20% and 40% by weight.

The amount is determined in practice by the required balance between shear strength and tack.

In accordance with a further advantageous embodiment, the fraction of tackifier resin is 40% to 80% by weight, more preferably between 60% and 80% by weight, when there are no further adjuvants or other additives.

The polyolefin of the invention may be combined with the elastomers known from rubber compositions, such as natural rubber or synthetic rubbers. Preference is given to using unsaturated elastomers such as natural rubber, SBR, NBR or unsaturated styrene block copolymers not at all or only in small amounts, which means that the fraction ought to be not more than 5% by weight. Synthetic rubbers with saturation in the main chain, such as polyisobutylene, butyl rubber, HNBR or hydrogenated styrene block copolymers are preferred in the case of a desired modification. Particularly preferred is a mixture of polyolefin of the invention with a copolymer having a composition which, apart from the comonomer, is similar—in other words, for example, a mixture of a grafted olefin copolymer and the same, ungrafted olefin copolymer, since by this means it is possible to reduce the raw materials costs.

The amount of tackifier resin is preferably 80 to 300 phr, more preferably 150 to 200 phr. “phr” denotes parts by weight of an additive relative to 100 parts by weight of rubber or polymer (parts by hundred rubber or resin), which here means based on 100 parts by weight of polyolefin.

Via the softening point of the tackifier resin (determination in accordance with DIN ISO 4625), the balance between shear strength and tack is adjusted, and is preferably between 85° C. to 125° C.

It has surprisingly emerged that tack and bond strength of the adhesive of the invention, in contrast to conventional rubber compositions, are highly dependent on the polydispersity of the resin. The polydispersity is the ratio of weight average to number average in the molar mass distribution, and can be determined by means of gel permeation chromatography (PD=M_{w}/Mₙ). Tackifier resins used are therefore those having a polydispersity of less than 2.1, preferably less than 1.8, more preferably less than 1.6. The greatest tack is achievable with resins having a polydispersity of 1.0 to 1.4. The weight-average molecular weight M_{w} and the number-average molecular weight Mₙ are determined by means of gel permeation chromatography (GPC). The eluent used is THF with 0.1% by volume of trifluoroacetic acid. Measurement takes place at 25° C. The preliminary column used is PSS-SDV, 5μ, 10³ Å, ID 8.0 mm×50 mm. Separation is carried out using the columns PSS-SDV, 5μ, 10³ and also 10⁵ and 10⁶ each with ID 8.0 mm×300 mm. The sample concentration is 4 g/l, the flow rate 1.0 ml per minute. Measurement is made against PMMA standards. (μ=μm; 1 Å=10⁻¹ m).

Highly suitable tackifier resins for the PSAs of the invention are resins based on rosin or on rosin derivatives (for example disproportionated, dimerized or esterified rosin), preferably in partially or completely hydrogenated form. Of all tackifier resins, they have the greatest tack, probably as a result of the low polydispersity of 1.0 to 1.2. Terpene-phenolic resins are likewise suitable, but result in only moderate tack, but on the other hand have very good shear strength and ageing resistance.

Preference is given to hydrocarbon resins, which are highly compatible presumably on account of their polarity. These resins are, for example, aromatic resins such as coumarone-indene resins or resins based on styrene or α-methylstyrene, or cycloaliphatic hydrocarbon resins from the polymerization of C₅ monomers such as piperylene from C₅ or C₉ fractions from crackers, or terpenes such as β-pinene or δ-limonene, or combinations thereof, preferably in partially or completely hydrogenated form, and hydrocarbon resins obtained by hydrogenation of aromatic-containing hydrocarbon resins or cyclopentadiene polymers.

If it is to be particularly tacky, the adhesive preferably comprises a liquid plasticizer such as, for example, aliphatic (paraffinic or branched), cycloaliphatic (naphthenic) and aromatic mineral oils, esters of phthalic, trimellitic, citric or adipic acid, liquid rubbers (for example low molecular weight nitrile rubbers, butadiene rubbers or polyisoprene rubbers), liquid polymers of isobutene and/or butene, liquid resins and plasticizer resins having a softening point of below 40° C. and based on the raw materials of tackifier resins, more particularly the above-recited classes of tackifier resin. Particular preference is given to liquid isobutene polymers such as isobutene homopolymer or isobutene-butene copolymer, and to liquid resins and plasticizer resins having a softening point below 40° C. Mineral oils are very inexpensive and are especially suitable for imparting tack to the polyolefin, but may migrate into bonding substrates such as paper; in one embodiment, therefore, the PSA is substantially free from mineral oils. The amount of plasticizer is preferably between 50 and 120 phr.

For optimization of the properties, however, the PSA employed may be blended with further additives such as primary and secondary antioxidants, fillers, flame retardants, pigments, UV absorbers, antiozonants, metal deactivators, light stabilizers, photoinitiators, crosslinkers or crosslinking promoters. Examples of suitable fillers and pigments include carbon black, titanium dioxide, calcium carbonate, zinc carbonate, glass fibres or polymer fibres, solid or hollow structures of glass or polymers such as microballoons, zinc oxide, silicates or silica. Additionally possible are adhesives of the invention without use of antioxidants and light stabilizers, since the stability is high in comparison to conventional rubber adhesives, this being an advantage for medical and packaging applications (food stuffs).

In accordance with one advantageous embodiment, the sum of the fractions of the additives does not exceed 5% by weight.

The pressure-sensitive adhesive of the invention may be applied to carrier materials by various methods. Depending on the existing plant, target coatweight, crosslinking reaction rate, and solubility of the polyolefin, the preparation and coating of the PSA may take place from solution or from the melt by coating on the carrier or by coextrusion with the carrier. Where the PSA is processed from solution, it is preferably prepared or dissolved in toluene and then applied (coated). Suitable preparation processes for a melt include both batch processes and continuous processes. Particular preference is given to the continuous manufacture of the PSA by means of an extruder and its subsequent coating directly onto the target substrate, with the adhesive at an appropriately high temperature. Preferred coating processes for the PSAs of the invention are extrusion coating with slot dies, and calender coating.

Depending on application, the subject matter of the invention can be used in a single-sided or double-sided adhesive tape. Where the adhesive tape has a multiple-layer construction, two or more layers may be applied atop one another by coextrusion, lamination or coating. Coating may take place directly onto the carrier or onto a liner, including an in-process liner.

The (pressure-sensitive) adhesive may be present
without carrier and without further layers,
without carrier, with a further PSA layer,
single-sidedly on a carrier, with the other side of the carrier bearing another PSA, preferably based on polyacrylate, or a sealing layer, or
double-sidedly on a carrier, in which case the two PSAs may have the same or different compositions.

In the double-sided adhesive tape utility, the adhesives are lined on one or both sides with a liner. The liner for the product or the in-process liner is, for example, a release paper or a release film with a release coating, preferably with a silicone coating. Liner carriers contemplated are, for example, films of polyester or polypropylene, or calendered papers, with or without a coating.

The coatweight (thickness of coating) of a layer is preferably between 15 and 300 g/m², preferably between 20 and 75 g/m².

The adhesive tape preferably has a bond strength to steel of at least 0.5 N/cm, more preferably at least 2 N/cm and more particularly at least 9 N/cm. The adhesive tape preferably has a bond strength to LDPE (PE-LD) of at least 2 N/cm, more preferably at least 4 N/cm and more particularly at least 8 N/cm. The bond strength is determined—unless otherwise specified—at a peel angle of 180° in accordance with AFERA 4001 on a test strip 15 mm wide. Substrate is a steel plate or a plate of LDPE, respectively, in accordance with AFERA 4001.

The adhesive tape preferably has a shear strength of at least 200 min, more preferably at least 1000 min, more particularly at least 5000 min. The test takes place in principle as described in EP 1 582 575 B1, paragraph [0066] (the tests carried out here take place at 23° C. on steel with a test weight of 1 kg). The shear strength is referred to there as the shear withstand time.

In the microshear travel test, the adhesive tape preferably has an elastic component of at least 15%, more preferably at least 50%. The test takes place in principle as described in EP 1 582 575 B1, paragraph [0067] (the tests carried out here take place at 40° C. on steel with a test weight of 100 g). The elastic component is calculated by the formula (pS1-pS2)/pS1 and is expressed in %.

The pressure-sensitive adhesive of the invention is preferably crosslinked chemically by reaction of the comonomer C. Polyolefins grafted with a vinylsilane such as vinyltriethoxysilane have the advantage that the crosslinking takes place by moisture only after melt coating, and yet the storage life is limited, owing to self-crosslinking, and, in the case of thick layers, the possibility for ingress of moisture is limited. Polyolefins grafted with hydroxyethyl acrylate, hydroxyethyl methacrylate, unsaturated acids or derivatives thereof have the advantage that their storage life is limitless and that, in the case of processing from solution, they can be crosslinked with crosslinkers customary for natural rubber adhesives and acrylate adhesives, such as isocyanates, epoxides, titanium compounds, aluminium compounds, oxazolines, aziridines or amines. Polyolefins grafted with acids or derivatives thereof can also be coated from the melt and crosslinked in parallel. Although this limits the selection of suitable crosslinkers, amines and epoxides can be admixed to the melt, given the right selection of crosslinker and process conditions, in such a way that the PSA is crosslinked and yet can be coated from the melt. In the case of processing from the melt, ionogenic crosslinking is particularly advantageous, since the crosslinking is thermally reversible and does not disrupt the operation of coating from the melt. The result of this is that the crosslinking is effective up to about above 100° C. for the end application, but permits thermoplastic processing above about 170° C. under the action of shearing and temperature. Suitable for this purpose are salts of the acids with monovalent and divalent metal ions, especially of zinc and magnesium. The salts can be generated by copolymerization or grafting of monomers such as zinc acrylate, or more simply by reaction of an acid-containing or acid anhydride-containing polymer with a metal compound such as zinc oxide or magnesium hydroxide. The grafting of an olefinic polymer with the comonomer may take place in the melt in an extruder or in a solid-phase process (from the company Kometra, for example). Since this generally takes place in the presence of peroxides, the olefinic polymer may be partly crosslinked which makes it impossible to use the polyolefin of the invention in solution and at least makes it more difficult to use it in the melt. Consequently, the selection of the process conditions and of the olefinic polymer are important. Saturated olefinic polymers, especially those with a low ethylene content, are more suitable in this respect than EPDM rubbers with a high fraction of diene monomers. A process which has proved to be particularly suitable is that in which an olefinic polymer in preferably 10% to 20% strength solution, for example in toluene or n-hexane, is grafted, preferably at the boiling point, with no crosslinking taking place. The solution then just needs to be admixed with the tackifier resin and any further additives, especially crosslinkers, to give a ready-to-use PSA.

As carrier material it is possible to use all known carriers, examples being scrims, woven fabrics, knitted fabrics, nonwovens, films, papers, tissues, foams and foamed films. Suitable films are of polypropylene, preferably oriented, polyester, unplasticized and/or plasticized PVC. Preference is given to polyolefin foams, polyurethane foams, EPDM and chloroprene foams. Polyolefin here refers to polyethylene and polypropylene, with polyethylene being preferred on account of the softness. The term “polyethylene” includes LDPE, and also ethylene copolymers such as LLDPE and EVA. Especially suitable are crosslinked polyethylene foams or viscoelastic carriers. The latter are preferably of polyacrylate, more preferably filled with hollow structures of glass or polymers.

Before being combined with the adhesive, the carriers may be prepared by priming or physical pretreatment such as corona. For double-sided adhesive tapes, crosslinked polyethylene foams are treated in this way, since the adhesion of acrylate PSAs to such foams is very poor and even with treatment is not very satisfactory. It is therefore completely surprising that the compositions of the invention adhere outstandingly to such foams even without treatment of the surface—in other words, in the case of a forceful attempt to detach them, the foam is destroyed.

The adhesive tape, especially if the carrier is composed of a polyolefin on the reverse, may be given a release coating of, for example, polyvinyl stearyl carbamate or a silicone.

The expression “adhesive tape” in the sense of this invention encompasses all sheetlike structures such as two-dimensionally extended films or film sections, tapes with extended length and limited width, tape sections, diecuts, labels and the like. The adhesive tape preferably takes the form of a continuous web in the form of a roll, and not a diecut or label. The adhesive tape may be produced in the form of a roll, in other words in the form of an Archimedean spiral rolled up onto itself.

The pressure-sensitive adhesive is particularly suitable for low-energy surfaces such as apolar paints, printing plates, polyethylene, polypropylene or EPDM, in others words, for example, for sealing or belting polyolefin pouches or for fixing parts of olefinic plastics or elastomers, especially plastics parts, to motor vehicles. The subject matter of the invention is therefore ideal for labels on cosmetics packaging (for example for body lotion bottles or shampoo bottles), since it is highly transparent, adheres well to plastic bottles, is water-resistant and is stable to ageing. In the case of security labels such as magnetic alarm labels or data carriers such as Holospot® (tesa Holospot® is a self-adhesive polymer label containing an information array just a few square millimetres in size; it adheres firmly to the product and contains various open and hidden security features, written into the information array beforehand using a high-resolution laser), the subject matter of the invention solves the problem of the poor adhesion of conventional adhesives to apolar substrates. The PSA of the invention in an adhesive tape is also suitable for bonding to skin and to rough substrates in the construction sector, as an adhesive packaging tape, and for wrapping applications. Examples of applications on skin are roll plasters and single plasters, diecuts for the bonding of colostomy bags and electrodes, active substance patches (transdermal patches), and bandages. On account of the stability to ageing, the PSA affords the possibility of avoiding substances that are skin irritants or have other chemical effects. The PSA of the invention is also suitable, therefore, for the construction of hygiene products such as nappy closures, nappies or sanitary towels, and, furthermore, adheres particularly to the polyolefin films and nonwovens used in such products, and has lower costs and higher heat stability than conventional hydrogenated styrene block copolymer compositions. Examples of wrapping applications are electrical insulation and the production of automotive cable looms. The adhesives of the invention, unlike natural or synthetic rubber adhesives, are compatible even at high temperatures with PP, PE and PVC wire insulation. In construction applications as a plaster tape, for the adhesive bonding of roof insulation films (barrier films against water vapour or liquid water) and as a bitumen adhesive tape for sealing applications and other outdoor applications, good bonding performance under low-temperature conditions is observed, as is a relatively good UV stability. Further applications are adhesive starting tapes for the continuous bonding of printed or unprinted film webs, and as adhesive barrier tape against diffusion of moisture and oxygen in photovoltaic modules or electronic components. The invention is additionally suitable for viscoelastic layers of adhesive, which are layers which at one and the same time fulfil a PSA function and a carrier function and have hitherto been manufactured from expensive polyacrylates in a layer thickness of approximately 0.5 to 3 mm, and in some cases are additionally provided with outer layers of more tacky polyacrylates.

The invention is illustrated below by a number of examples, without wishing thereby to restrict the invention.

### RAW MATERIALS OF THE EXAMPLES

Lucalen A 2910 M: terpolymer of 89% by weight ethylene, 7% n-butyl acrylate and 4% acrylic acid, melting point 96° C., heat of fusion 73 J/g, flexural modulus about 84 MPa, density 0.927 g/m³, melt index 7 g/10 min
Lotryl 7 BA 01: copolymer of ethylene and 7% n-butyl acrylate, melt index 1.3 g/10 min, density 0.930 g/cm³, flexural modulus 85 MPa, melting point 107° C.
Engage 7447: copolymer of ethylene with butene, melting point 35° C., flexural modulus 8 MPa, density 0.865 g/m³, melt index 5 g/10 min before grafting and, after grafting, 0.33 g/10 min
Tafmer A 0550 S: copolymer of ethylene and butene, melt index 0.5 g/10 min before grafting and, after grafting, 0.03 g/10 min, density 0.861 g/cm³, flexural modulus 7 MPa, crystallite melting point 45° C.
Infuse 9817: copolymer of ethylene with octene, melting point 120° C., flexural modulus 23 MPa, density 0.877 g/m³, melt index 15 g/10 min before grafting and, after grafting, 4 g/10 min
Vistamaxx 3000: copolymer of propylene and ethylene, melt index before grafting 7 g/10 min at 230° C. and 4.7 at 190° C., density 0.871 g/cm³, flexural modulus 40 MPa, crystallite melting point 56° C., heat of fusion 29.8 J/g
Elvaloy AC 3517 Si: terpolymer of ethylene with 17% butyl acrylate and about 1% vinylsilane, melt index 5.3 g/10 min, density 0.924 g/cm³, flexural modulus 40 MPa, crystallite melting point 97° C., heat of fusion 60.6 J/g
Elvaloy 3717: copolymer of ethylene with 17% butyl acrylate, melt index 7 g/10 min, crystallite melting point 96° C.
Keltan DE 5005: ethylene-propylene rubber based on Keltan 3200 grafted with 2% maleic anhydride, ethylene content 49%, Mooney after grafting 65.
Keltan 3200 A: ethylene-propylene rubber, ethylene content 49%, Mooney 20
Buna EP XT 2708 VP: ethylene-propylene rubber, 68% ethylene, ENB 0%, 0.8% maleic anhydride grafted, Mooney 28, melt index 0.10 g/10 min
Buna EP G 2170 VP: EPDM, ethylene content 72%, Mooney 25, ENB 1.2%, density 0.86 g/cm³, melt index 0.0 g/10 min at 190° and 0.1 g/10 min at 230° C.
Ondina 933: white oil (paraffinic-naphthenic mineral oil)
Indopol H-100: polyisobutene-polybutene-copolymer having a kinematic viscosity of 210 cSt at 100° C. to ASTM D 445
Wingtack 10: liquid C₅ hydrocarbon resin
Wingtack 95: non-hydrogenated C₅ hydrocarbon resin having a melting point of 95° C.
Escorez 1310: non-hydrogenated C₅ hydrocarbon resin having a melting point of 94° C. and a polydispersity of 1.5
Epicure 925: triethylenetetramine, serves as crosslinker or as a crosslinking accelerator for epoxide crosslinking
Polypox H 205: α,ω-diamino-polypropylene oxide
Polypox R-16: pentaerythritol tetraglycidyl ether
Desmodur VP LS 2371: isophorone diisocyanate prepolymer
Irganox 1726: phenolic antioxidant with sulphur-based function of a secondary antioxidant
Irganox 1076: phenolic antioxidant
Tinuvin 622: HALS light stabilizer
Q-Cel 5025: hollow glass beads
Zinc oxide, active: finely divided zinc oxide for rubber crosslinking, from Bayer

### Example 1

Tafmer A 0550 S is grafted on an extruder with 1% by weight of maleic anhydride. 25.5 parts by weight of the polymer, 54 parts by weight of Escorez 1310, 20 parts by weight of Ondina 933 and 0.5 part by weight of Irganox 1726 are mixed in the melt and coated with a coatweight of 300 g/m² onto a 25 μm polyester film etched with trichloroacetic acid.

### Example 2

Implementation like Example 1, but additionally with 1 part by weight of Epicure 925 per 100 parts by weight of adhesive (polymer and additives).

### Example 3

Infuse 9817 is grafted on an extruder with 1% by weight of maleic anhydride. 25.5 parts by weight of the polymer, 50 parts by weight of Escorez 1310 and 27 parts by weight of Wingtack 10 are mixed in the melt and coated with a coatweight of 250 g/m² onto a 25 μm polyester film etched with trichloroacetic acid.

### Example 4

Implementation like Example 3, but additionally with 1 part by weight of Epicure 925 per 100 parts by weight of adhesive.

### Example 5

Implementation like Example 3, but additionally with 4.35 parts by weight of Polypox H 205 per 100 parts by weight of adhesive.

### Example 6

Implementation like Example 3, but additionally with 1 part by weight of Polypox R-16 and 0.2 part by weight of Epicure 925.

### Comparative Example 1

Implementation like Example 3, but with ungrafted Infuse 9817.

### Example 7

100 parts by weight of Vistamaxx 3000 are dissolved in 900 parts by weight of toluene under reflux. 0.5 part by weight of maleic anhydride and 0.025 part by weight of Perkadox 16 (peroxide from Akzo Nobel) are added with stirring and the solution is boiled under reflux for 2 hours. An adhesive is then prepared from the graft polymer. Composition (without solvent fraction): 28 parts by weight of graft polymer, 54 parts by weight of Wingtack 95 and 18 parts by weight of Ondina 933. Coating with a coatweight of 50 g/m² onto a 25 μm polyester film etched with trichloroacetic acid, and subsequent drying.

### Example 8

Preparation takes place in the same way as in Example 7, but with the addition of 1.65 parts by weight of aluminium acetylacetonate per 100 parts by weight of inventive polymer.

### Example 9

Preparation takes place in the same way as in Example 7, but with the addition of 3.3 parts by weight of aluminium acetylacetonate per 100 parts by weight of inventive polymer.

### Comparative Example 2

Preparation takes place in the same way as in Example 7, but Vistamaxx 3000 without grafting (no maleic anhydride and no Perkadox 16).

### Example 10

Preparation takes place in the same way as in Example 7, but with hydroxyethyl methacrylate instead of maleic anhydride. Prior to coating, the adhesive is admixed with 8.45 parts by weight of Desmodur VP LS 2371 per 100 parts by weight of inventive polymer.

### Example 11

On a planetary roller extruder, the following components are mixed:

| | |
|---|---|
| 100 phr | Lucalen A 2910M |
| 100 phr | Escorez 1310 |
| 50 phr | Q-Cel 5025 |
| 10 phr | zinc oxide active |
| 2 phr | Irganox 1726 |
| 1 phr | Tinuvin 622. |

The mixture is shaped on a roll applicator unit to form a layer of adhesive weighing 1000 g/m². This layer is corona-treated on both sides and laminated with 100 g/m² of an acrylate composition per side. The acrylate composition is prepared as follows:

A reactor conventional for free-radical polymerizations is charged with 45 kg of 2-ethylhexyl acrylate, 45 kg of n-butyl acrylate, 5 kg of methyl acrylate, 5 kg of acrylic acid and 66 kg of acetone/isopropanol (92.5:7.5). After nitrogen gas has been passed through the reactor for 45 minutes with stirring, the reactor is heated to 58° C. and 50 g of AIBN are added. The external heating bath is then heated to 75° C. and the reaction is carried out constantly at this external temperature. After 1 hour a further 50 g of AIBN are added, and after 4 hours dilution takes place with 20 kg of acetone/isopropanol mixture. After hours and again after 7 hours, re-initiation takes place with 150 g of bis(4-tert-butylcyclohexyl) peroxydicarbonate each time. After a reaction time of 22 hours the polymerization is discontinued and cooling takes place to room temperature. The polyacrylate has a conversion of 99.6%, a K value of 59, a solids content of 54%, an average molecular weight of Mw=557 000 g/mol, polydispersity PD (Mw/Mn)=7.6. The acrylate polymer solution is freed from the solvent with an extruder under reduced pressure, and in a second step is blended in a ratio of 70 parts by weight acrylate polymer to 30 parts by weight Dertophene DT 1100 and also with an epoxy crosslinker and an amine accelerant. This acrylate composition is subsequently applied to a double-sidedly siliconized polyester film at 100 g/m² and is laminated with the layer of polyurethane adhesive described above. The bond strength measurements are determined under a peel angle of 90°.

### Example 12

28 parts by weight of Lucalen A 2910 M, 54 parts by weight of Escorez 1310 and 18 parts by weight of Indopol H-100 are mixed in the melt and coated at a coatweight of 250 g/m² onto a 25 μm polyester film etched with trichloroacetic acid.

### Example 13

Preparation takes place in the same way as in Example 12, but with addition of 2 parts by weight of Polypox R-16 and 2 parts by weight of Polypox H-205, in each case per 100 parts by weight of adhesive (polymer and additives without solvent).

### Comparative Example 3

Preparation takes place in the same way as in Example 12, but with Lotryl 7 BA 01 instead of Lucalen A 2910 M.

### Example 14

Engage 7447 is grafted on an extruder with 1% by weight of maleic anhydride. 28 parts by weight of the polymer, 54 parts by weight of Escorez 1310, 18 parts by weight of Ondina 933 and 0.5 part by weight of Irganox 1076 are mixed in the melt and coated from the melt with a coatweight of 300 g/m² onto a 25 μm polyester film etched with trichloroacetic acid.

### Example 15

The adhesive has the formula of Example 14 but is prepared in solution (toluene), coated onto a 25 μm polyester film etched with trichloroacetic acid, and dried. The coatweight runs to 50 g/m².

### Comparative Example 4

Like Example 14, but with ungrafted Engage 7447.

### Example 16

Preparation takes place in the same way as in Example 15, but with addition of 1.65 parts by weight of aluminium acetylacetonate, based on polymer.

### Example 17

25.5 parts by weight of Elvaloy AC 3517 Si, 54 parts by weight of Escorez 1310 and 20 parts by weight Ondina 933 are mixed in the melt and coated with a coatweight of 225 g/m² onto a 25 μm polyester film etched with trichloroacetic acid.

### Example 18

Preparation takes place in the same way as in Example 17, but the specimen is stored prior to measurement for crosslinking at 80% relative humidity and 40° C. for 3 days.

### Comparative Example 5

Preparation takes place in the same way as in Example 17, but with Elvaloy 3717.

### Example 19

28 parts by weight of Keltan DE 5005, 54 parts by weight of Escorez 1310 and 18 parts by weight of Ondina 933 are prepared in solution (toluene), coated onto a 25 μm polyester film etched with trichloroacetic acid, and dried. The coatweight runs to 50 g/m².

### Example 20

Preparation takes place in the same way as in Example 19, but with addition of 1.89 parts by weight of Polypox H 205, based on polymer.

### Comparative Example 6

Preparation takes place in the same way as in Example 19, but with Keltan 3200 A.

### Example 21

28 parts by weight of Buna EP XT 2708 VP, 54 parts by weight of Escorez 1310 and 18 parts by weight of Ondina 933 are prepared in solution (toluene), admixed with 3.3 parts by weight of aluminium acetylacetonate, based on polymer, then coated onto a 25 μm polyester film etched with trichloroacetic acid, and dried. The coatweight runs to 50 g/m².

### Comparative Example 7

Preparation takes place in the same way as in Example 21, but with Buna EP G 2170 VP.

### Results

E=example, CE=comparative example, CF=cohesion failure (adhesive splits), AF=adhesion failure (adhesive delaminates from the substrate without flowing)

| No. of example | Bond strength | Bond strength | Shear strength | Microshear | Microshear |
|---|---|---|---|---|---|
| or comparative | steel | LDPE | at 23° C. | travel | travel, elastic |
| example | [N/cm] | [N/cm] | [min.] | [μm] | component [%] |
| E 1 | — | 5 | 230 | — | — |
| E 2 | — | 4.7 | 312 | — | — |
| E 3 | — | 12 | 46 | | |
| E 4 | — | 6 | 13 AF | — | — |
| E 5 | — | 6 | 1 AF | — | — |
| E 6 | — | 6 | 8 AF | — | — |
| CE 1 | >20 CF | 13 | 1 | — | — |
| E 7 | 7.6 | 2.3 | 7343 | 40.5 | 0.35 |
| E 8 | 9.3 | 3.4 | 7094 | 19 | 76 |
| E 9 | 8.9 | 2.5 | >10 000 | 14 | 57 |
| CE 2 | 8.7 | 4.2 | 51 | 1405 | 0.02 |
| E 10 | 4.8 | 3.7 | >10 000 | 11 | 73 |
| E 11 | 30 | 13 | >10 000 | — | — |
| E 12 | 11 | 3 | 90 | — | — |
| E 13 | — | 2 | 20 | — | — |
| CE 3 | does not | does not | | | |
| | stick | stick | | | |
| E 14 | — | 11 | 3 values | — | — |
| | | | >10 000, | | |
| | | | 1 value 95 AF | | |
| E 15 | >20 CF | 7.4 | 1821 | 743 | 9.8 |
| E 16 | — | 1.3 | 4536 | 205 | 19 |
| CE 4 | >20 CF | 3.8 | 45 | 1600 | 0.03 |
| E 17 | — | 15 | 105 | — | — |
| E 18 | | 10 | 3 values | | |
| | | | >10 000, | | |
| | | | 1 value 22 AF | | |
| CE 5 | — | 12 | 75 | — | — |
| E 19 | 15 CF | 4.7 | 160 | 95 | 41 |
| E 20 | 6.6 | 2.5 | 3077 | 34 | 50 |
| CE 6 | — | 14 | 25 | — | — |
| E 21 | — | 2 | 3872 | 147 | 8.6 |
| CE 7 | — | 0.9 | 2503 | 680 | 0.9 |

Through the incorporation of a polar monomer, the cohesion (resistance to cold flow) is improved, apparent from higher shear strength and lower microshear travel. On incorporation of acids or anhydrides without exclusion of moisture, this can be explained by the polar interaction via hydrogen bonds. The improvement is increased drastically by crosslinking in particular. Crosslinking results in particular in a considerable elastic component in the microshear travel measurement, which tells the skilled person that the cold flow in the course of time (of the flow path) is interrupted or at least considerably reduced by opposing forces from the deformed network. On addition of too high an amount of crosslinker there may be adhesive fracture (AF), and the shear strength begins to show great scatter, because the samples do not shear off but instead undergo chance delamination (see for example 4 to 6). Overcrosslinking may also be manifested by a deterioration in elastic components of the microshear travel, because in that case the polymer then already behaves somewhat like a thermoset; this phenomenon is also well known with acrylate PSA. Through the incorporation of a polar monomer it is possible to raise the bond strength on polar substrates such as steel, but reduce it on apolar substrates such as LDPE. The bond strengths are reduced by crosslinking, as is known for solvent compositions based on natural rubber and acrylate.

1. A pressure-sensitive adhesive comprising a crosslinkable polyolefin and at least one tackifier resin, wherein the polyolefin is composed of at least two monomers, A and B, and of at least one comonomer C amenable to crosslinking, the monomers A and B being selected from the group consisting of α-olefins, vinyl acetate, n-butyl acrylate and methyl methacrylate, and ethylene propylene diene monomer (EPDM).

2. The pressure-sensitive adhesive according to claim 1, wherein the at least two monomers A and B of the crosslinkable polyolefin are α-olefins.

3. The pressure-sensitive adhesive according to claim wherein the polyolefin has a melt index of less than 10.

4. The pressure-sensitive adhesive according to claim 1 wherein the polyolefin is a terpolymer of ethylene, of an ester of acrylic or methacrylic acid and of a comonomer which is amenable to crosslinking, or is a copolymer grafted with the comonomer, selected from the group of the copolymers of ethylene and propylene, the copolymers of propylene and butene, the copolymers of hexene or octene, the copolymers of propylene and butene, and the terpolymers of ethylene, propylene and a diene from the group of 5-ethylidene-2-norbornene, dicyclopentadiene and 5-vinyl-2-norbornene.

5. The pressure-sensitive adhesive according to claim 1 wherein the polyolefin is obtainable by copolymerization of the at least two monomers A and B with the comonomer C.

6. The pressure-sensitive adhesive according to claim 1 wherein the polyolefin is obtainable by polymerization of the at least two monomers A and B in order to form a polymer, and grafting of the comonomer C onto the polymer.

7. The pressure-sensitive adhesive according to claim 1 wherein the pressure-sensitive adhesive comprises a plasticizer selected from the group of mineral oils, liquid tackifier resins, liquid polymers of isobutene homopolymer and/or isobutene-butene copolymer, and esters of phthalic, trimellitic, citric or adipic acid.

8. A process for preparing a pressure-sensitive adhesive tape comprising applying the pressure-sensitive adhesive according to claim 1 from a toluene solution to a carrier and crosslinking the adhesive with a crosslinker selected from the group consisting of an isocyanate, an epoxide, a titanium compound, an aluminium compound, an oxazoline, an aziridine and an amine.

9. A process for preparing a pressure-sensitive adhesive tape comprising applying the pressure-sensitive adhesive according to claim 1 from a melt to a carrier, and crosslinking the adhesive with a crosslinker selected from the group consisting of an epoxide, an amine, a zinc compound and a magnesium compound.

10. A single-sided or double-sided adhesive tape comprising an adhesive according to claim 1, the adhesive tape having at least on one side a bond strength to steel of at least 0.5 N/cm.

11. The single-sided or double-sided adhesive tape according to claim 10 wherein the coatweight of the pressure-sensitive adhesive in one coat being between 15 and 300 g/m².

12. The single-sided or double-sided adhesive tape according to claim 10 wherein the shear strength is at least 200 min and/or the elastic component from the microshear travel test is at least 15%.

13. The single-sided or double-sided adhesive tape according to claim 10, wherein the tape comprises a polyethylene foam carrier whose surfaces in contact with the adhesive have not been (pre)treated.

14. The single-sided or double-sided adhesive tape according to claim 13 wherein the carrier is a nonwoven, a tissue, a film or a foam.

15. (canceled)

16. The pressure-sensitive adhesive according to claim 1 wherein the EPDM is selected from the group consisting of 5-ethylidene-2-norbornene, dicyclopentadiene and 5-vinyl-2-norbornene.

17. The pressure-sensitive adhesive according to claim 2 wherein the α-olefin is selected from the group consisting of ethylene, propylene, butene, hexene and octane.

18. The pressure-sensitive adhesive according to claim 1 wherein the polyolefin has a Mooney viscosity greater than 5.

19. The pressure-sensitive adhesive according to claim 5 wherein the comonomer C is selected from the group consisting of fumaric acid, acrylic acid, methacrylic acid or itaconic acid.

20. The single-sided or double-sided adhesive tape according to claim 10 wherein the adhesive tape has at least on one side a bond strength to steel of at least 9 N/cm.
